(19) United States
(12) Patent Application Publication
(10) Pub. No.: US 2005/0111940 A1
(43) Pub. Date: May 26, 2005

(54) Device with parts rotatble in relation to one another and a sealing means

(76) Inventors: Joachim Markert, Augsburg (DE); Gunther Merk, Altenmunster (DE)

Correspondence Address: MCGLEW & TUTTLE, PC, 1 SCARBOROUGH STATION PLAZA, SCARBOROUGH, NY, 10510-0827, US

(21) Appl. No.: 10/969,685

(22) Filed: Oct. 20, 2004

(30) Foreign Application Priority Data
Oct. 21, 2003 (DE) 103 48 841.3

(51) Int. Cl. B65G 1/00; B65G 65/00; E03B 1/00; F17D 1/00

(52) U.S. Cl. 414/314; 414/315; 414/316

(57) ABSTRACT

A device (1) with at least two parts (2, 3) rotatable in relation to one another, such as a gear mechanism, especially for a multiaxial industrial robot, in which a seal (4) is arranged between the parts (2, 3) rotatable in relation to one another, is wherein at least one additional seal (5) is arranged between the parts (2, 3) rotatable in relation to one another. The device (1) thus has a sealing arrangement (4, 5), which reliably prevents both the entry of water and/or dirt into the device and the escape of potentially contaminating substances from the device into the environment. The device (1) can thus also be used in areas that are at risk for contamination, such as in the food-processing industry.

### CROSS REFERENCE TO RELATED APPLICATIONS

This application claims the benefit of priority under 35 U.S.C. § 119 of DE 103 48 841.3 filed Oct. 21, 2004, the entire contents of which are incorporated herein by reference.

### FIELD OF THE INVENTION

The present invention pertains to a device with at least two parts rotatable in relation to one another, such as a gear mechanism, especially for a multiaxial industrial robot, wherein a seal is arranged between the parts rotatable in relation to one another.

### BACKGROUND OF THE INVENTION

Handling gear in the form of multiaxial industrial robots, as they are nowadays used for many industrial applications, usually have a plurality of parts that are rotatable in relation to one another. To prevent, on the one hand, dirt, for example, dust, or moisture from penetrating into the interior of the robot at the necessarily open interfaces of such parts rotatable in relation to one another and, on the other hand, lubricant fumes, abraded particles or the like from being able to be released from the robot into the environment, seals are usually arranged at the interfaces in such devices.

A device of this type in conjunction with a multiaxial industrial robot has been known, for example, from EP 0 934 805 A2. The subject of the document has a plurality of axes and housing parts that are rotatable in relation to one another, and a seal each is arranged between these in the form of a sealing ring. Moisture and dust are to be prevented by means of the seals from penetrating into the robot from the outside, so that the robot can be used without a risk of damage to its inner components in the food-processing industry as well.

The fact that both moisture and contaminants can enter the robot and substances, such as lubricant fumes or abraded particles can escape from the robot into the ambient space, which may lead to considerable problems with corresponding cost consequences especially in the food industry because of contamination of the foods being processed even in case of a slight damage to one of the seals, shall be considered, in particular, to be a drawback here.

### SUMMARY OF THE INVENTION

The basic object of the present invention is to improve a device of the type described in the introduction such that it can also be used safely in an environment with risk for contamination and inner components of the device are protected from environmental effects at the same time.

This object is accomplished in a device of the type described in the introduction by an additional seal being arranged between the parts rotatable in relation to one another. The second seal can thus also assume the function of the other seal in case of failure of one of the seals. A sealing means, which reliably prevents pollutants from entering the device and contaminating substances from escaping into a working area of the device, is thus formed according to the present invention.

Provisions are made in a variant of the device according to the present invention for the seals to have an essentially ring-shaped design, in which case they may be preferably arranged concentrically. Especially simple and efficient seals can thus be obtained in case of parts that are rotatable in relation to one another and therefore usually have a rotationally symmetrical design.

Provisions are made within the framework of an especially preferred embodiment of the device according to the present invention for the first part to have on its front side facing the second part a first recess and a second recess, which are engaged by corresponding, complementary first and second projections of the second part. To achieve reliable sealing between the parts rotatable in relation to one another in such a device, a seal is advantageously arranged between a limiting surface of the first projection and a limiting surface of the first recess, and a seal is arranged between the limiting surface of the second recess and the second projection.

To obtain a simple geometry of the sealing surfaces, the first projection and the first recess have an essentially regular cylindrical shape in an extremely preferred variant of the present invention. For the same reason, the second projection and the second recess may have an essentially ring-shaped design. The second projection and the second recess may concentrically surround the first projection and the first recess, respectively.

In a variant of the device according to the present invention, an essentially closed gap, to which pressure can advantageously be admitted, is formed between the seals. It is thus possible, on the one hand, to support the seals from the inside during cleaning operations, e.g., by means of a high-pressure cleaning means, in order to prevent detergents from entering the device. On the other hand, the space between the seals can thus be rinsed with a fluid, such as disinfectant solution, in order to thus prevent microorganisms from growing in the interior of the device and a subsequent contamination of the environment of the device.

Provisions are made in a preferred variant of the device according to the present invention for one of the seals to be designed as a sealing lip that is in contact with one part from the outside, which advantageously has a concave arch against an external space of the device, so that the entry of substances into the device is made difficult especially during the cleaning operations and dirt spaces are generally prevented from forming. To guarantee the sealing action especially of the inner seal when pressure is admitted into the gap, provisions may, furthermore, be made for one of the seals to have a concave profile at least on its side facing away from the gap. To further improve the possibility of using a device according to the present invention for applications involving a risk for contamination, such as in the food industry, the seals are preferably made of PTFE (polytetrafluoroethylene) or a comparable pollutant-reducing material, for example, a fluorinated elastomer, ethylene-propylene-diene rubber (EPDM, likewise an elastomer) or polyoxymethylene (POM; a thermoplastic).

Provisions are made in an extremely preferred, concrete variant of the device according to the present invention for one of the parts rotatable in relation to one another to be designed as a housing for a gear mechanism, especially for a multiaxial industrial robot, and for the other part to exit from same, especially in the form of a drive shaft or a power take-off shaft.

Other properties and advantages of the present invention will appear from the following description of exemplary embodiments on the basis of the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a side view of a multiaxial industrial robot;

FIG. 2 is a schematic view of the device according to the present invention;

FIG. 3 is a detailed, cutout sectional view of a first embodiment of the device according to the present invention;

FIG. 4 is a detailed, cutout sectional view of a second embodiment of the device according to the present invention;

FIG. 5 is a detailed, cutout view of another embodiment of the device according to the present invention; and

FIG. 6 is a detailed, cutout view of another embodiment of the device according to the present invention.

### DESCRIPTION OF THE PREFERRED EMBODIMENTS

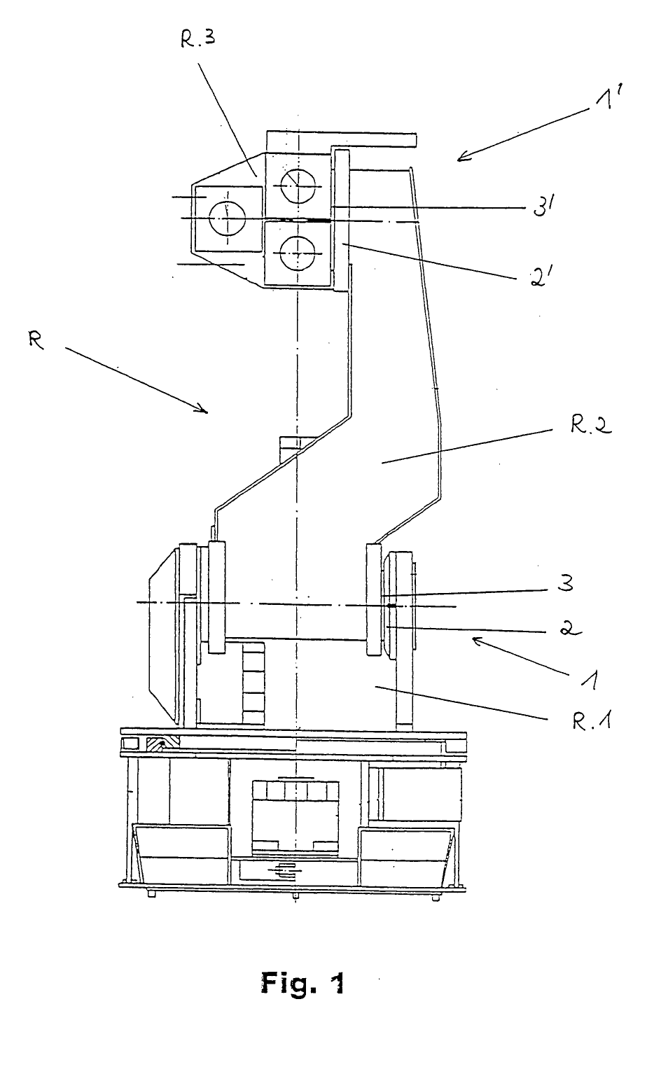

FIG. 1 shows a rear view of a multiaxial industrial robot R. At least in its joint areas between the frame R.1 and the rocker R.2 or the rocker and arm R.3, the robot R has devices 1, 1′ according to the present invention with parts 2, 3 and 2′, 3′ that are rotatable in relation to one another.

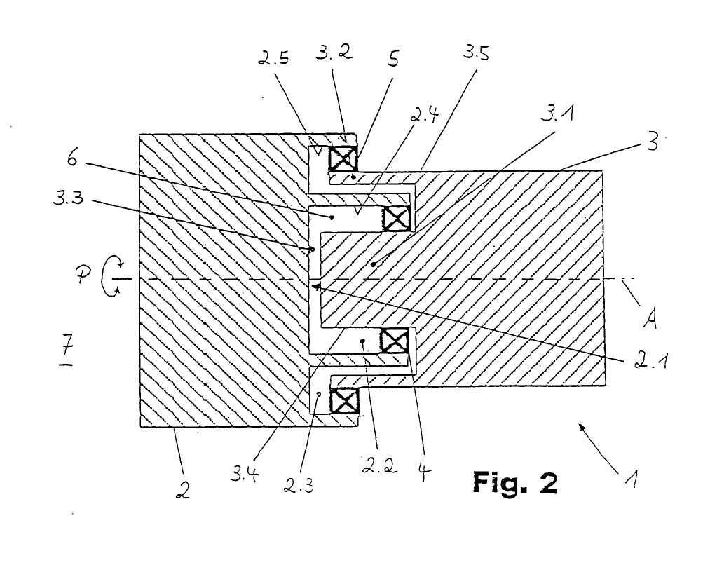

FIG. 2 shows a schematic sectional view of a device 1 according to the present invention with a first part 2 and a second part 3, which are rotatable in relation to one another around an axis A of the device 1 (arrow P in FIG. 2). The parts 2, 3 shown may be, for example, a gear mechanism housing 2 and a drive or power take-off shaft 3 in a multiaxial industrial robot (not shown).

On its front side 2.1 facing the part 3, the first part 2 has a first recess 2.2 and a second recess 2.3, which engage corresponding, complementary first and second projections 3.1, 3.2 on a front side 3.3 of the second part 3.

Furthermore, the first projection 3.1 and the first recess 2.2 have an essentially regular cylindrical shape according to FIG. 2, while the second projection 3.2 and the second recess 2.3 are essentially ring-shaped. The second projection 3.2 and the second recess 2.3 concentrically surround the first projection 3.1 and the first recess 2.2, respectively, in relation to the axis A.

A first ring-shaped seal 4 is arranged between an outer limiting surface 3.4 of the first projection 3.1 and an inner limiting surface 2.4 of the first recess 2.2. A second, likewise ring-shaped seal 5 is arranged concentrically with the seal 4 between an inner limiting surface 2.5 of the second recess 2.3 and an outer limiting surface 3.5 of the second projection 3.2. According to the embodiment shown in FIG. 2, an essentially concentric—albeit optionally axially offset—arrangement of the seals 4, 5 is obtained in relation to the axis A of the device 1.

Furthermore, the first projection 3.1 and the first recess 2.2 have an essentially regular cylindrical shape according to FIG. 2, while the second projection 3.2 and the second recess 2.3 are essentially ring-shaped. The second projection 3.2 and the second recess 2.3 surround the first projection 3.1 and the first recess 2.2, respectively, concentrically in relation to the axis A.

Furthermore, it can be determined from FIG. 2 that an essentially closed gap 6, which has an approximately S-shaped cross section in case of the special embodiment and arrangement of the projections 3.1, 3.2 and recesses 2.2, 2.3 as shown, is formed between the seals 4, 5.

In case of the above-mentioned design of the first part 2 as a housing part and of the second part 3 as a drive shaft or power take-off shaft of a gear mechanism, both seals 4, 5 are located according to FIG. 2 between the usually stationary housing and the drive shaft or power take-off shaft which rotates relative thereto. In case of such an embodiment, the inner seal 4 may be a usual gear mechanism seal known to the person skilled in the art. The outer seal 5 provided additionally is preferably made of a material compatible with foods, for example, PTFE, EPDM, POM or a fluorinated elastomer. According to the view shown in FIG. 2, the inner seal 4 retains a gear mechanism lubricant and thus prevents contamination of the environment, while the outer seal 5 prevents water and dirt from entering the device 1 according to the present invention. The gap 6 located between the seals 4, 5 supports both seals, while in case of failure of one of the seals 4, 5, the respective other seal assumes the protective function of the other seal. The device 1 thus created according to the present invention is consequently especially suitable for use in the food-processing industry because of its special sealing means 4, 5.

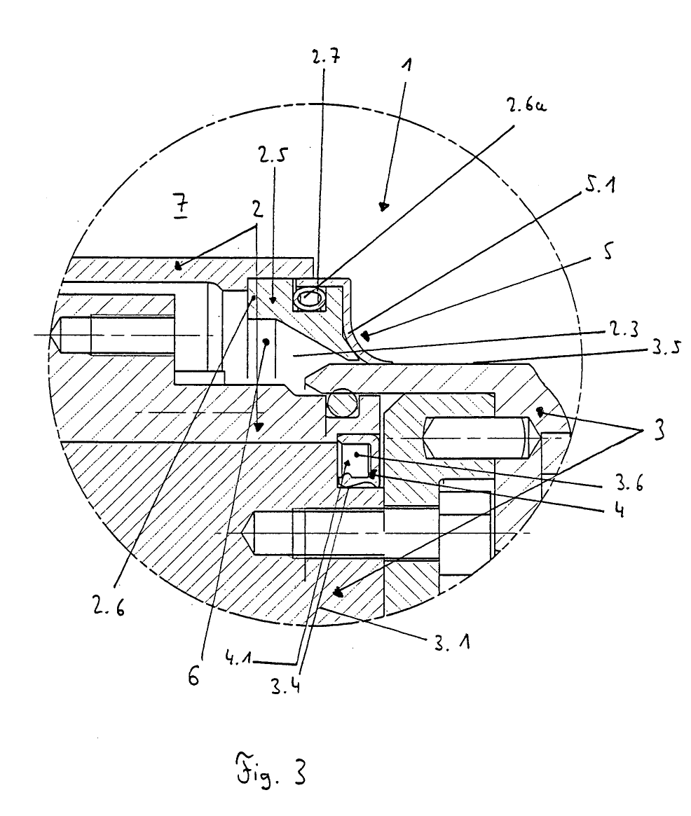

FIGS. 3 through 6 show additional concrete embodiments of the device according to the present invention in a detailed form, corresponding components of the device being designated by the same reference numbers for comparison with the schematic view in FIG. 2.

According to FIG. 3, the outer seal 5 is designed as a simple peripheral sealing lip 5.1, which is designed, e.g., arched concavely against an outer space 7, for example, a working space of a robot, such that dirt spaces are generally prevented from forming, and the sealing lip is in contact with the outer limiting surface 3.5 of the second part 3 of the device 1. Good sealing action is achieved in this manner even in case of the action of pressure on the seal 5 from the outside, for example, when the device 1 is cleaned by means of a cleaning device. The sealing lip 5.1 is arranged according to FIG. 3 between an inner limiting surface 2.5 of the outer recess 2.3 and a ring-shaped insert 2.6 arranged in the recess 2.3 and is held by means of a ring-shaped holding means 2.7 arranged in a peripheral groove 2.6a of the insert 2.6.

The inner seal 4 is designed in the object according to FIG. 3 as a ring-shaped seal with an essentially U-shaped profile and is arranged such that on its side 4.1 facing away from the gap 6 it has a profile, for example, a concave profile, by which dirt spaces are prevented from forming. To receive the seal 4, the projection 3.1 of the rotating (driven) part 3 has a peripheral recess 3.6 in its outer limiting surface 3.4.

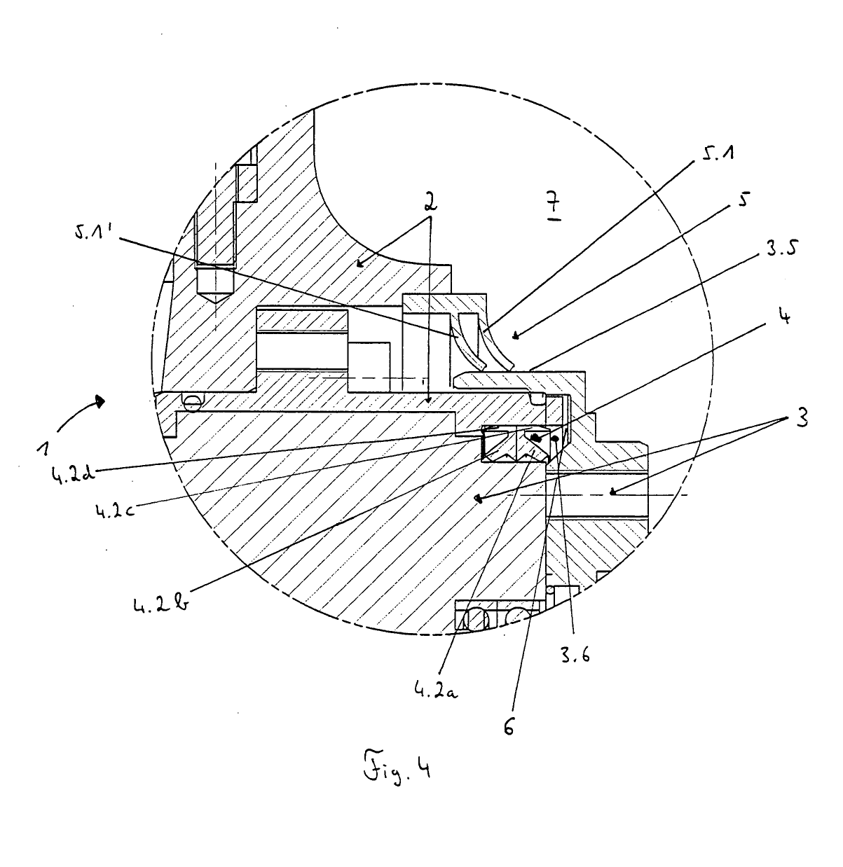

According to the embodiment of a device according to the present invention as shown in FIG. 4, the outer seal 5 is provided with two essentially mutually parallel sealing lips 5.1, 5.1′ and is arranged between the first part 2 and the second part 3 without an insert 2.6 (FIG. 3). The inner seal 4 has a double U-shaped profile in this embodiment, and free legs 4.2a-d of the inner seal 4 are arranged such that the seal has a concave profile both on its side facing the gap 6 and on its respective sides 4.1 and 4.2 facing away from the gap 6.

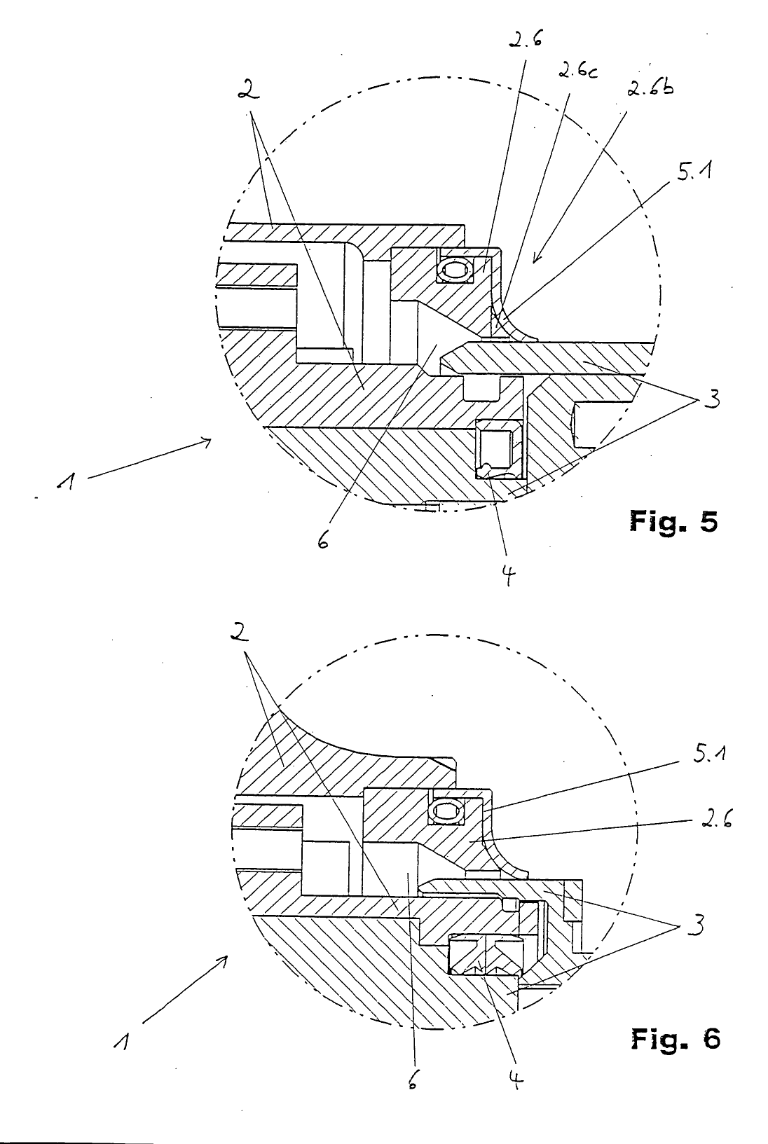

Unlike in FIG. 3, the insert 2.6 is not of a one-piece design in the object according to FIG. 6, but is provided in the area of its outer front side 2.6b with a ring-shaped attachment 2.6c having a wedge-shaped cross section, via which the arch can be adapted to the sealing lip 5.1. For reasons of clarity, not all reference numbers are shown in FIG. 5 as well as in FIG. 6 (cf. FIGS. 3 and 4).

FIG. 6 shows essentially a device 1 according to the present invention corresponding to FIG. 3, but with an inner seal 4 according to FIG. 4.

While specific embodiments of the invention have been shown and described in detail to illustrate the application of the principles of the invention, it will be understood that the invention may be embodied otherwise without departing from such principles.

### Appendix

List of Reference Numbers

1, 1′ Device
2, 2° First part, housing
2.1 Front side
2.2 Recess
2.3 Recess
2.4 Limiting surface
2.5 Limiting surface
2.6 Insert
2.6a Groove
2.6b Attachment
2.7 Holding means
3, 3′ Power take-off
3.1 Projection
3.2 Projection
3.3 Front side
3.4 Limiting surface
3.5 Limiting surface
3.6 Recess
4 Seal
4.1 Side
4.2a-d Free leg
5 Seal
5.1, 5.1′ Sealing lip
6 Gap
7 Outer area, environment
A Axis
P Rotation
R Robot
R.1 Frame
R.2 Rocker
R.3 Arm

1. A device comprising:
two parts rotatable in relation to one another;
a seal arranged between the two parts rotatable in relation to one another; and
an additional seal arranged between the two parts rotatable in relation to one another.

2. A device in accordance with claim 1, wherein each of said seal and said additional seal have an essentially ring-shaped design.

3. A device in accordance with claim 2, wherein each of said seal and said additional seal are arranged concentrically.

4. A device in accordance with claim 1, wherein said two parts comprise a first part and a second part, said first part having a front second part facing side with a first recess and a second recess, said second part having a first projection that is corresponding and complementary to said first recess and a second projection that is corresponding and complementary to said second recess, said first recess being engaged by said first projection and said second recess being engaged by said second projection.

5. A device in accordance with claim 4, wherein said seal is arranged between a limiting surface of said first projection and a limiting surface of said first recess, and said additional seal is arranged between a limiting surface of said second recess and said second projection.

6. A device in accordance with claim 4, wherein said first projection and said first recess have essentially a regular cylindrical shape.

7. A device in accordance with claim 4, wherein said second projection and said second recess are essentially ring-shaped.

8. A device in accordance with claim 4, wherein the second projection and said second recess concentrically surround said first projection and said first recess, respectively.

9. A device in accordance with claim 1, wherein an essentially closed gap is formed between each of said seal and said additional seal.

10. A device in accordance with claim 1, wherein said additional seal is designed to prevent dirt spaces from forming.

11. A device in accordance with claim 1, wherein one of said seal and said additional seal has a sealing lip that is in contact with one of said first part and said second part from an outside.

12. A device in accordance with claim 11, wherein the sealing lip is made concavely arched against a outer space.

13. A device in accordance with claim 9, wherein said seal has a concave profile at least on a side facing away from the gap.

14. A device in accordance with claim 1, wherein at least one of said seal and said additional seal is made of polytetrafluoroethylene (PTFE), ethylene-propylene-diene rubber (EPDM), polyoxymethylene (POM) or a fluorinated elastomer.

15. A device in accordance with claim 9, wherein said gap defines a pressure space in wherein pressure can be admitted into the gap.

16. A device in accordance with claim 4, wherein said first part is a housing part of a gear mechanism of a multiaxial industrial robot, and said second part exits from said housing part as a drive shaft or power take-off shaft.

17. A device in accordance with claim 2, wherein said two parts comprise a first part and a second part, said first part having a front second part facing side with a first recess and a second recess, said second part having a first projection that is corresponding and complementary to said first recess and a second projection that is corresponding and complementary to said second recess, said first recess being engaged by said first projection and said second recess being engaged by said second projection.

18. A device in accordance with claim 5, wherein said first projection and said first recess have essentially a regular cylindrical shape.

19. A device in accordance with claim 5, wherein said second projection and said second recess are essentially ring-shaped.

20. A multiaxial industrial robot comprising:
a first robot part;
a second robot part rotatable in relation to said first robot part;
a seal arranged between said first robot part and said second robot part;
an additional seal arranged between said first robot part and said second robot part, said first robot part having a second robot part facing side with a first recess and a second recess, said second robot part having a first projection that is corresponding and complementary to said first recess and a second projection that is corresponding and complementary to said second recess, said first recess being engaged by said first projection and said second recess being engaged by said second projection.
